(19) United States
(12) Patent Application Publication
(10) Pub. No.: US 2016/0130044 A1
(43) Pub. Date: May 12, 2016

(54) CAP FOR DRINKS BOTTLE WITH POSSIBILITY FOR FEEDING A GASEOUS MEDIUM

(71) Applicant: KRONES AG, Neutraubling (DE)

(72) Inventor: BERND SOBIECH, Regensburg (DE)

(73) Assignee: KRONES AG, Neutraubling (DE)

(21) Appl. No.: 14/896,238

(22) PCT Filed: Jun. 4, 2014
(86) PCT No.: PCT/EP2014/061587

§ 371 Date: Dec. 4, 2015

(30) Foreign Application Priority Data
Jun. 4, 2013 (DE) 10 2013 105 761.6

(51) Int. Cl. B65D 41/50; B67D 1/12

(52) U.S. Cl. CPC B65D 41/50; B67D 1/1279

(57) ABSTRACT

Container cap for liquid containers, comprising a receiving region for receiving a mouth section of the container, a fastening means for arresting the container cap on the container, and a covering means for completely covering a mouth of the container, wherein a first opening can be provided in this covering means when the container cap is arrested on the container, via which opening a first fluid can be removed from or fed to the liquid container, wherein this opening is located at least partially within the mouth cross-section of the mouth of the liquid container. The container cap has a predetermined opening section which is located outside of the mouth of the container and by means of which a flow connection to the internal volume of a liquid container on which the container cap is arrested can be established.

The present invention relates to a drinks bottle and to a cap for a drinks bottle. In addition, the invention relates to a method for removing liquids from drinks bottles and also to a production method for such a drinks bottle.

So-called bulk containers or bulk packs, which are used for example in catering outlets and tap-based systems, have been known for a long time from the prior art. Containers for use in these tap-based systems (so-called single-use kegs or party kegs with a holding capacity of between 5 I and 50 I or for use in dispensers (usually in the form of PET bottles with a capacity of up to 5 I) are stretch blow moulded for example from plastic preforms, filled and capped.

From the applicant's internal prior art, it is also known that the containers are first capped and only then are filled. In these cases, the filling takes place through the cap. Furthermore, containers which are used multiple times in a reusable process are also known. In addition, usually metal containers are used in the prior art.

The containers are usually provided with caps having a valve function, known as fittings. These fittings have a liquid valve which serves for dispensing liquid and/or for filling the container. In addition, these caps in some cases also have a gas valve, through which filling functions, such as, for example, pre-loading, flushing with inert gas or releasing pressure, can be performed in the event of filling through the cap. In addition, a pressure medium for aiding the dispensing of the liquid located in the container can also be fed through these valves. A pressure release after a process of emptying the container, for example a tapping process, can also be carried out through these valves.

In the prior art, such valve functions are always arranged within the container mouth, since a fluid connection between a drinks dispensing line and the container interior must be established. The neck region of the container, which is usually cylindrical, has a mouth rim for sealing with respect to a top face of the cap, as well as, for example, outer latching elements for making it possible to fix the cap to a neck region of the container. In addition, the container often has one or more carrying rings at which the container can be handled or transported in a filling plant. In addition, internal or external threads may also be provided for fixing a cap to the container.

Since these valves or valve functions of the fitting are arranged within the mouth, the neck region usually has a correspondingly large diameter of up to 60 mm and more. A large amount of material, that is to say PET in particular, is thus wasted in this neck region. Correspondingly, the fittings also have a large diameter, which is associated with further material expenditure.

The object of the present invention is therefore to reduce the material consumption in the production of such containers and/or container caps. This object is achieved by the subjects of the independent claims.

Advantageous embodiments and further developments form the subject matter of the dependent claims.

A container cap according to the invention for liquid containers has a receiving region for receiving a mouth section of the liquid container. The container cap also has a fastening means for arresting the container cap on the container, and also a covering means for completely covering a mouth opening of the liquid container. A first opening can be made in this covering means when the container cap is arrested on the container, via which opening a first fluid can be removed from and/or fed to the liquid container, wherein this opening is located at least partially within the mouth cross-section of the mouth of the liquid container.

According to the invention, the container cap has (in particular when arranged on the container or on the mouth thereof) a predetermined opening section which is located outside of the mouth or of the mouth cross-section of the container and by means of which a (second) flow connection to the internal volume of the liquid container on which the container cap is arrested, can be established. A fluid, that is to say in particular a liquid or preferably a gas, can also be communicated between the interior of the container and the surrounding environment via this second flow connection.

It is therefore proposed that the container cap itself has two predetermined opening sites, via which two flow paths, which are preferably separate from one another (at least in some sections), to the container can be established. As mentioned above, one of these openings is located within the mouth cross-section of the container and the other is located outside of the mouth cross-section. Advantageously, said second opening is located outside of said mouth cross-section in a radial direction in relation to a longitudinal direction of the container. In this way, it is possible to leave the mouth cross-section of the container relatively small, since the feeding of a second medium, for example of carbon dioxide, is carried out via an opening which is located outside of the mouth cross-section of the container. In one advantageous embodiment, the container cap is made of a plastics material. It is thus possible that this container cap has predetermined opening sites, for example thinned areas of material, valve devices or the like, in the region in which the openings are to be located.

In a further advantageous embodiment, the first opening is located entirely within the mouth cross-section of the mouth. Advantageously, a liquid is removed from the container via this first opening. However, it would also be possible that a gas is fed to the container via the first opening, for example for pressure loading purposes.

Hereinbelow, a description will be given in particular of that alternative in which gas is fed or removed outside of a mouth region and liquid is removed or fed within the mouth diameter. However, the invention can also apply inversely, so that the liquid is removed through the opening arranged laterally next to the mouth cross-section and thus preferably is also removed through a side opening in the neck region of the container and thus liquid is correspondingly fed or removed on the outside of the neck region of the container and, conversely, the gas is fed and/or removed within the mouth diameter or the mouth cross-section. Preferably, therefore, both openings serve for fluid communication, wherein this relates both to a liquid and to a gas. Advantageously, however, one opening serves for gas communication and the other opening serves for liquid communication.

Since only one valve, in particular the liquid valve, is now arranged within the mouth cross-section, at which valve for example a riser may still be arranged, the neck region can have a much smaller diameter, for example around 28 mm. This leads to a much lower material consumption. In addition, further material is saved due to the cutting-out of the gas outlet holes (in the container), which may be located for example in the mouth region. The invention can advantageously be used for plastic single-use kegs without a liner. However, it can also be used on containers made of other materials, such as, for example, plastics, metals and the like, wherein the containers or caps may also have so-called liners. In addition, however, the invention could also be used on reusable containers.

Advantageously, the liquid can be removed from the container without compressing the container itself. In a further advantageous embodiment, the container cap has a line which connects to at least one opening and leads into the interior of the container. Advantageously, this line is connected to the first opening or the first predetermined opening site, which is located within the mouth cross-section. In this case it is possible that such a line, hereinafter also referred to as the riser, is led to the bottom of the container. In this way, the container can be substantially completely emptied even when it is not being compressed. It is possible in this case that said line is designed to be flexible, for example as a flexible hose, which connects to the respective opening.

In a further advantageous embodiment, the arresting means has an engaging device which engages behind a portion of the container in order to arrest the container cap. For example, the arresting means may engage behind a carrying ring of the container. It may also engage in a groove on the container, instead of behind the carrying ring. Further material can be saved as a result.

Advantageously, the container cap has a circumferential wall which is designed to run around the entire mouth of the container when the container cap is arrested on the container. In a further advantageous embodiment, the arresting means is also designed to run around the circumference. However, it would also be possible that the arresting means cooperates with an external thread of the container in order to arrange the container cap on the container.

In a further advantageous embodiment, the second predetermined opening section is spaced apart from the first opening. As mentioned above, it is possible that both the first opening (or a first predetermined opening section) and the second predetermined opening section are arranged in said covering means. Advantageously, these are arranged in such a way that they do not overlap with one another but rather are separated from one another by a material section. In this way, it is possible to achieve the situation whereby one opening is located entirely outside of the mouth of the container and the other opening is located entirely within the mouth.

In a further advantageous embodiment, the covering means is configured as a covering surface which projects beyond the mouth of the liquid container.

Preferably, the second predetermined opening section is formed in this covering surface and in particular in that section of the covering surface which projects beyond the mouth rim. In this case it is possible that this covering surface is for example circular and thus projects symmetrically beyond the mouth rim. However, it would also be possible that the covering surface projects beyond the mouth rim only in one region in the circumferential direction of the mouth and the second predetermined opening section is arranged in this region.

Advantageously, the covering surface comprises, at least in one region, a material which can be pierced or cut. This means that, in this region, an opening can be produced without deforming the covering surface in such a way that the sealing effect elsewhere is cancelled.

In a further advantageous embodiment, the container cap has a first sealing means for sealing the covering means with respect to the mouth rim of the mouth. For example, the mouth region of the container can still have a sealing region at which a fluid-tight sealing between the container cap and the mouth region can take place.

A connection between the mouth section and the mouth of the container may take place for example by welding, adhesive bonding or also by arranging a sealing element such as an O-ring. By virtue of this sealing or the sealing means, a gas passage cavity is formed. The sealing region is thus not the conventional sealing between the mouth rim and a cap. Advantageously, this sealing region between the mouth of the container and the cap is configured in such a way that it completely separates from one another the two flow connections between the container and the environment surrounding the container, which are mentioned above.

It is thus also possible that the container cap has a receiving region for receiving the mouth section of the container and one of said openings is located within this receiving region and the other is located outside of this receiving region, in particular in the radial direction. A liquid dispensing region is preferably arranged in a top wall of the container cap and particularly preferably centrally therein. In this case, a liquid valve may be provided, to which the abovementioned riser is optionally and preferably connected.

As mentioned, this riser may be of flexible or rigid construction and preferably extends to the bottom of the container in the installed position. As mentioned, this riser serves on the one hand for removing liquid, but on the other hand it can also serve for filling the container. The top wall or the covering means need not necessarily have a liquid valve. It is also possible that the covering means has a piercing region for a tap fitting, on which a liquid dispensing line (in particular in the form of a tap line) is also arranged, wherein in this case the piercing region is advantageously located within a cross-section of a riser.

Advantageously, the region of liquid dispensing is somewhat smaller in diameter than the mouth internal diameter of the container, or the mouth internal diameter is adapted to the space required for the liquid dispensing system. The covering means or the top wall can at least partially seal and bear against the mouth rim of the container in the installed position. This possibly leads to a greater stability of the arrangement consisting of the container and the cap arrested thereon.

As mentioned, the second opening is preferably arranged in the covering means or top region. As an alternative or in addition, however, it would also be possible to arrange the second opening in a side wall or circumferential wall of the container cap. The cross-section of the container cap is preferably selected to be larger than a mouth cross-section of the liquid container so that, when the container cap is placed or arrested on the liquid container, a channel and in particular a gas channel is formed which runs around the mouth of the container at least in some sections and preferably completely.

As mentioned above, the container cap preferably has at least one valve device. In this case, a valve device may be provided for the feeding and removal of liquid but also for a corresponding feeding or removal of gas. In a further advantageous embodiment, at least one such valve device is assigned to the predetermined opening section and/or a flow connection thereto exists.

For instance, one of these valve devices, and in particular the valve device arranged outside of the mouth rim of the container, may be a gas valve. This gas valve may open into a cavity between the cap side wall and the mouth region of the container, wherein this gas valve may also be arranged within said cavity. Preferably, this gas valve can establish a fluid connection between the external environment surrounding the cap (this also being understood to mean a gas feeding and removal line) and a cavity between the cap side wall and the mouth region of the container. The gas feed and/or removal region can also be configured in such a way that no valve is used, but rather a piercing region for a tap fitting is provided.

The abovementioned circumferential wall or side wall of the container cap is not necessarily cylindrical or formed with a circular cross-section. It may be sufficient that the side wall has a shaped area on which in particular the abovementioned gas valve is arranged and which forms said cavity. In this case, the abovementioned gas channel does not run around the entire circumference of the container cap but rather only a region of the circumference, and is arranged in particular laterally next to the mouth rim of the container.

In this case, it is possible that corresponding gas passage openings in the mouth region of the container also open into said cavity. In this embodiment, the container and/or the cap preferably has orienting elements. Such orienting elements may function in a purely mechanical manner, in particular are detected for example by sensors when arranging the container cap on the container or else in a bottling plant, wherein then the orientation takes place by the respective handling elements of the bottling plant.

The abovementioned sealing section of the cap or the sealing region is adapted in terms of its shape to the sealing region of a mouth region of the container. Both are advantageously circular. However, it would also be possible that an orienting function is generated by this sealing region itself if the cap side wall is not cylindrical and has a shaped area for a valve, in particular a gas valve. In the cap/container arrangement, said sealing region is preferably located below the gas passage openings, wherein for “below” reference is made to an upright container in which the mouth is directed upwards.

Advantageously, the cavity outside of the neck region is at least large enough that an arrangement for passing compressed gas through the cap has sufficient space to function.

The positioning and/or shape of the cavity to be formed outside of the neck region, as well as the type and positioning of the liquid and gas transfer regions through the cap wall, is also possible in numerous other combinations and variants.

As mentioned, the invention can also be used with containers which have a so-called liner. The latter may for example be co-extruded or introduced subsequently into the finished container. Advantageously, said liner is introduced only after the gas passage openings have been formed, so that the liner is not damaged during this method step. Preferably, the liner is arranged above the gas passage openings on the neck region. With particular preference, it is adhesively bonded or welded to the neck region. Such a liner can also be clamped between the mouth rim and the cap by the cap/container arrangement. It is also possible that the liner is introduced with the container cap and optionally the riser arranged thereon into the container. In this case, the liner may already be attached to the cap and/or to the riser and/or to the valve.

When using a liner, it is advantageous that the drink cannot pass through the gas outlet openings into the abovementioned cavity between the mouth of the container and the cap side wall. The arrangement and/or positioning of the gas passage openings in the container is then also no longer so important. The flexibility with regard to the pressure medium during the emptying process is also advantageous. In this case, there is no need to use product gas, for example CO₂, but rather simply compressed air or even a liquid medium can be used.

Liquids can be removed from an upright container and also from an upside-down container (in which the neck region projects downwards). In this case, a different arrangement of the fluid passage opening may also be preferred.

The present invention is also directed to a liquid container having a container cap of the above type arrested or able to be arrested thereon. In this case, the liquid container has, when closed by the container cap, an opening via which the liquid container is or can be flow-connected and in particular gas-connected to an intermediate space formed between the liquid container and the container cap.

Ideally, such a cavity is provided outside of an external circumference of the container, in the mouth region thereof. The liquid container, as will be described in more detail below, may preferably have a plurality of openings in the mouth region. In a further advantageous embodiment, the container also has a carrying ring or a groove, behind which a section of the container cap can engage.

The present invention is also directed to a method for removing liquid from a liquid container, wherein a container cap is arrested on a mouth of this liquid container and the liquid is removed while the cap is arrested on the liquid container. According to the invention, a first opening is made in the container cap in order to enable a first fluid connection and in particular a liquid connection for removing the liquid from the liquid container. Furthermore, a second opening is made in the container cap in order to add a second fluid connection and in particular a gas connection between the interior of the liquid container and the environment surrounding the liquid container.

In this case, one and preferably the first opening is located within the mouth cross-section of the container and the other opening is located outside of the mouth cross-section of the container. Advantageously, the first opening, via which liquid is fed or removed, is located within the mouth cross-section of the container and the second opening, which in particular is located outside of the mouth rim of the container, serves for gas exchange, in particular for feeding a gas.

Advantageously, the two openings are made in such a way that they are completely separate from one another. In a further advantageous embodiment, the container has, in addition to its mouth opening, preferably a further opening.

In a further advantageous method, the liquid is removed without any squeezing or compressing of the container.

In a further advantageous embodiment, the liquid is removed by means of a line which connects in particular to the container cap. This line advantageously projects into the liquid located within the container, and particularly preferably this line reaches to a bottom of the liquid container. The method is advantageously composed of the following steps:
providing a liquid-filled container
arranging the container in a removal station
connecting the cap to a suitable removal fitting
removing liquid from the container by applying a pressure medium to the interior of the container (wherein the interior may also be an intermediate space between the container wall and a liner)
conducting pressure medium through media passage openings which are preferably arranged in a neck region of the container or
transferring gas from a cavity arranged on the neck outer side.

It is pointed out that the order of the abovementioned steps is not binding and some of the steps can even be carried out simultaneously. Some of said steps are also mentioned as alternatives, so that not all of said steps must be carried out. Preferably, however, the gas passage opening is not a conventional mouth opening of the container. Preferably, during the removal of liquid, compressed gas is introduced into a cavity between the cap and the neck region of the container.

The present invention also relates to a container and in particular to a plastic container and particularly preferably to a plastic container made of PET for accommodating liquids. This plastic container has a main body which encloses an accommodation volume for accommodating the liquid. The container also has a mouth section for feeding and/or removing the liquid, wherein this mouth section has a first opening via which liquid can be removed from the container.

According to the invention, at least a second opening is provided in the mouth section, via which second opening a gaseous medium can be fed at least at times to the container, wherein the planes in which the first opening and the second opening are arranged differ from one another.

There is thus also proposed a container which is used in particular in conjunction with the to container cap mentioned above and which, in contrast to containers known from the prior art, has at least one further opening in addition to the mouth opening. Via this further opening, a gas can be fed to the container, for example in order to remove the liquid. Conversely, however, it would also be possible to feed the gas via the conventional mouth opening and to remove the liquid for example via the further opening.

The container is advantageously a container formed in one piece. It is also advantageously a single-walled container.

A neck region of the container thus preferably has a mouth opening. The container can be filled or emptied via this mouth opening. To this end, for example, parts of the abovementioned cap or fitting in this mouth opening can project into the container interior. The first opening or the mouth opening preferably has a mouth rim which, for stability reasons, particularly preferably can bear against the cap in a receiving region of the cap for the mouth rim. The container cap can bear with this receiving region for the mouth rim only against the mouth rim and in doing so can be sealed preferably entirely or partially.

This mouth rim advantageously also defines the side on which gas or liquid is fed and/or removed.

Therefore, as mentioned above, a container is also proposed, in particular for use in a drinks dispenser such as a tap-based system, in which the neck region has at least one additional (gas) passage opening. The above-described gas transfer from the interior of the container to the outside, and vice versa, can take place through this gas passage opening. The diameter of the neck region can thus be at least partially reduced in comparison to conventional diameters, since the gas is no longer removed or fed within the mouth diameter but rather outside of the latter.

The gas passage openings serve for the passage of gas during at least the following process steps: inlet and/or outlet of gas into/from a container interior when filling is taking place through the cap or the fitting (for example flushing with inert gas, pre-loading, pressure release, optionally flushing with inert gas and sterilizing), for fluid inlet for a tap fluid during drinks dispensing;

optionally for an outlet of fluid when releasing pressure from an emptied container, which serves in particular for safety reasons.

Advantageously, the container has in the upright state a sealing region which is located particularly preferably at least below the openings. Advantageously, a container cap can bear in a fluid-tight manner against this sealing region, for example at a carrying ring or at a ring provided additionally for sealing purposes. Between this ring and a mouth rim, a cavity may be formed for example between the neck region and a cap side wall or between a sealing region and a cap top wall. In this region and preferably also in the top wall of the cap, a gas outlet region may be provided and in particular a gas valve may be arranged, which gas valve can particularly preferably also be actuated from outside.

In a further advantageous embodiment, the mouth region has a circumferential wall surrounding the first opening, and the second opening is arranged in this circumferential wall. In this embodiment, preferably the openings are completely separate from one another. However, it would also be possible that the openings in the circumferential wall also project into a region of the mouth rim and therefore a separation of the openings is brought about only by the placing-on or arresting of the container cap. For instance, recesses could be provided for example in the circumferential rim of the mouth. When a sealing region is then placed onto this circumferential rim, a separation into a mouth opening and into the openings in the circumferential wall is simultaneously achieved by this region.

In a further advantageous embodiment, a plurality of spaced-apart second openings are provided in the mouth section. In particular, said second openings are spaced apart from one another in the circumferential direction of the mouth section. In this way, a further material saving can be achieved.

In a further advantageous embodiment, the first plane and the second plane are substantially perpendicular and in particular perpendicular to one another. In this case, it may in particular be provided that the circumferential wall which surrounds the first opening is cylindrical. In a further advantageous embodiment, a circumferential ring which extends at least also in a radial direction of the container is arranged on the mouth section. This ring advantageously extends substantially precisely in a radial direction and in particular also perpendicular to a longitudinal direction of the container. This ring may be a carrying ring of the container, by means of which the latter can be transported for example. However, this carrying ring can also serve for sealing with respect to the container cap.

In a further advantageous embodiment, at least one second opening has a circular or slot-shaped cross-section. Such openings are easy to form during production.

In general, one or more openings and in particular gas passage openings may be arranged in the neck region. If just one gas passage opening is provided, a cavity adjoining this opening, which cavity is formed between the container cap and the mouth, is advantageously also oriented towards this gas passage opening. The abovementioned circular holes can relatively easily be drilled, milled, punched or pierced or even melted using a hot needle. A slot-shaped opening in turn is highly suitable for (vibration) cutting. However, it would also be possible that the openings are oval or of some other shape. It would also be possible to configure the opening in the shape of a certain character, for example a company logo, so that in this way the opening also serves to indicate the manufacturer.

In this case, it would be conceivable that said second openings are provided at the time of container production or at the time of production of the associated plastic preforms, for example when the plastic is still in a plastically deformable state. In particular, the openings may in this case be arranged in the aforementioned neck region. It would also be possible to create these openings on a plastic preform that has already been produced or that is already finished. In addition and preferably, it is also possible to create the (gas) passage openings on a finished container, since then the usual stretch blow moulding process is no longer negatively affected. Alternatively, it would also be conceivable that the gas passage openings are optionally additionally sealed off during a stretch blow moulding process, so that the blowing fluid does not exit through said openings. This may also advantageously take place with a stretch blow moulding machine which, during the stretch blow moulding process, seals off the blowing nozzle on a carrying ring of a container or on the stretch blow mould.

In a further advantageous embodiment, the openings are arranged at an angle, in particular at an angle from the outside to the inside in relation to the mouth wall. For instance, it may be preferred that the openings are arranged in such a way that product fractions which slosh through the (gas) passage openings during transport can also flow back into the container interior. In this way, emptying of drinks residues can be encouraged. As mentioned above, said openings are preferably arranged above a neck region of the container, at which the container cap adjoins the neck region in a fluid-tight manner (hereinafter also referred to as the sealing region) and by which the (gas) passage cavity is formed.

The present invention is also directed to a method for producing a plastic container and in particular a plastic container of the type described above, wherein a plastic preform is provided which is then transformed by a blow moulding process into a plastic container. According to the invention, at least one second opening is formed during or after production of the plastic preform. Advantageously, the plastic container is produced by a stretch blow moulding process.

In a further advantageous method, at least one second opening is produced after the transforming process. In this way, as mentioned above, it is possible to avoid the situation whereby the second openings hinder the expansion process, which takes place in particular by means of blowing pressure.

In a further advantageous method, at least one second opening is produced by a mechanical operation. This mechanical operation is selected from a group of operations which includes drilling, milling, cutting, punching, melting, combinations thereof and the like.

In a further advantageous embodiment, at least one second opening is arranged above the abovementioned ring. Above is to be understood here to mean that the second opening is arranged closer than said ring to the first opening in the longitudinal direction of the container.

In a further advantageous embodiment, the at least one second opening is arranged closer to the ring than to the first opening. In this way, on the one hand a valve device can be more easily accommodated in a cap and on the other hand the flow conditions, in particular for feeding a gas to the container interior, can also be facilitated and thus in particular a more favourable flow can be achieved.

The mouth region of the container thus preferably has a connection region at which the container cap is or can be connected to the mouth region. This connection region may in this case also have an internal thread and/or an external thread. Particularly when using an external thread, an engagement region for a quality feature, such as, for example, a “tamper evidence ring”, may additionally be present. It would also be possible that, as an alternative or in addition, a different type of misuse safeguard is present.

As an alternative or in addition, the connection region may also be a latching site or have a latching site, at which latching site the cap latches onto the neck region of the container. Such a latching site may be provided on a mouth region or on the aforementioned carrying ring. The arrangement of a cap on the neck region is influenced by the aforementioned connection region in such a way that a sealing can also actually take place at a sealing region.

The neck region may optionally also have a carrying region, such as a carrying ring for example. At this carrying ring, the container is for example handled, gripped and/or transported. A carrying handle may also be held on this carrying ring. However, it would also be possible that the container is held in some other way, for example in a standing position or on its trunk or main body.

In addition, it is also possible that the aforementioned sealing regions, carrying regions and connection regions in each case also perform more than one of the stated functions. For instance, solely by way of example, the carrying region can also serve as the sealing region. For example, the container can be supported and thus carried via the underside of the carrying ring and can be sealed via an upper side of the carrying ring. In addition, it would also be possible that the cap is welded or adhesively bonded to a carrying ring or the carrying region serves as a connection region, wherein for example the cap, as will be shown in more detail below, can latch onto an underside of the carrying ring.

In a further advantageous embodiment, it would also be possible that the diameter of the neck region is not reduced in its entirety but rather is reduced only in one part. For example, the upper part of the container mouth could be reduced in diameter and could have the (gas) passage openings. An external thread with a sealing ring (which acts as the sealing region) located thereabove could be arranged for example below the (gas) passage openings, wherein the thread could then have a conventional diameter. A carrying ring of conventional diameter could then be arranged below the thread, so that largely the usual container handling in the bottling plant can be used. If the neck diameter is reduced, this may otherwise lead to unstable transport, so that additional guide fittings for the container may be used or may have to be used.

If a thread is used for attaching the cap, the aforementioned second openings and in particular gas passage openings are preferably located below an internal and/or external thread of the neck region, onto which the cap is screwed. Alternatively, it would also be conceivable that the gas passage openings or the second openings are located above an external thread, but then the thread preferably provides fluid-tight sealing directly below the second openings. To this end, an additional sealing element could also be arranged there.

Alternatively, it would also be conceivable that the second openings are also arranged within the thread or the thread turns. It would then be conceivable that openings and in particular (gas) passage channels are possibly arranged in the thread itself. Via these openings, a gas could then be conducted to or from a gas passage cavity. However, this might possibly make emptying of residues more difficult.

In addition, as mentioned above, it would also be conceivable that the second openings are formed by notches or the like in the mouth rim. In this case, too, it may be more difficult to empty residues. In this example of embodiment, it is advantageous if these notches are designed as slots, in particular as slots running as far as the sealing region, between the cap and a carrying ring.

In a further advantageous embodiment, a further ring could be provided which can also be used as a carrying ring and which also serves as a sealing region for the container cap. Said second openings are then preferably arranged above this upper ring.

A plastic preform or a container and in particular a drinks dispensing container is thus proposed which has, particularly in its neck region, openings and in particular gas passage openings so that the gas can be removed from or fed to an outer side of the neck region.

The method for producing the described container may also be composed of the following steps, wherein, here too, the order thereof is not binding and some of the steps may even be carried out simultaneously. Furthermore, some of the following steps are also mentioned as alternatives, so that a suitable choice can be made.

In one method step, a plastically deformable workpiece is produced or a plastic preform is produced or the latter is provided. In a further method step, a container is produced from the plastic preform or, as mentioned above, alternatively the container is produced from the plastic preform with sealing of gas passage openings. Gas passage openings are then created. In a further method step, this container can be transported, wherein it is also conceivable in particular that a container having gas passage openings is transported.

In addition, further method steps may be provided which concern in particular the further handling, filling and capping. For example, firstly a container is provided and optionally also transported. The (gas) passage openings can then be created. In one method step, material residues resulting from the creation of the (gas) passage openings are removed. In a further step, the container can be filled, wherein preferably medium or gas also passes through the (gas) passage openings into the neck region of the container. This can facilitate the filling process, since filling can take place entirely via the mouth and at the same time the air located inside the container can escape.

In a further method step, an additional treatment of the container is also possible, such as, for example, a sterilizing of its inner region, its outer region, in particular neck outer region, a flushing with inert gas, a pre-loading or a release of pressure. Furthermore, the container may be closed in particular with the container cap mentioned above.

Depending on the embodiment of the fluid passage openings, it may advantageously be necessary that a sealing of the filling valve, for example on the carrying ring, also takes place for example by a movable contact bell.

Furthermore, a filling method may also be such that a process gas flows through a cavity between a container cap and the container neck.

Further advantages and embodiments will become apparent from the appended figures, in which:

FIG. 1 shows a diagram of a mouth section of a container with a cap arranged thereon;

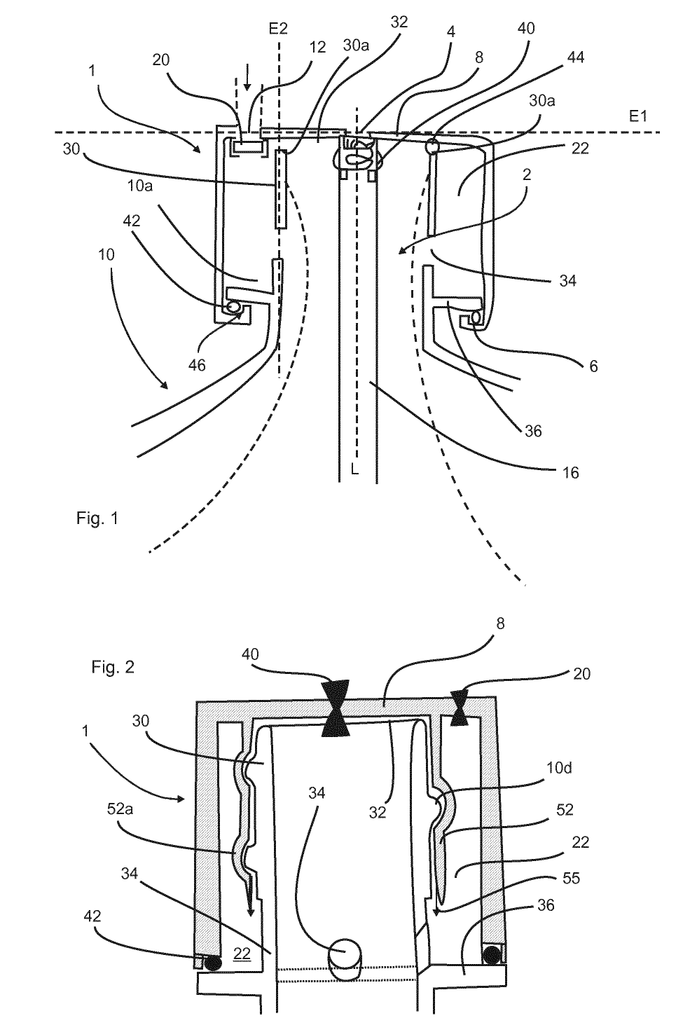

FIG. 2 shows a container mouth with a cap in a second embodiment;

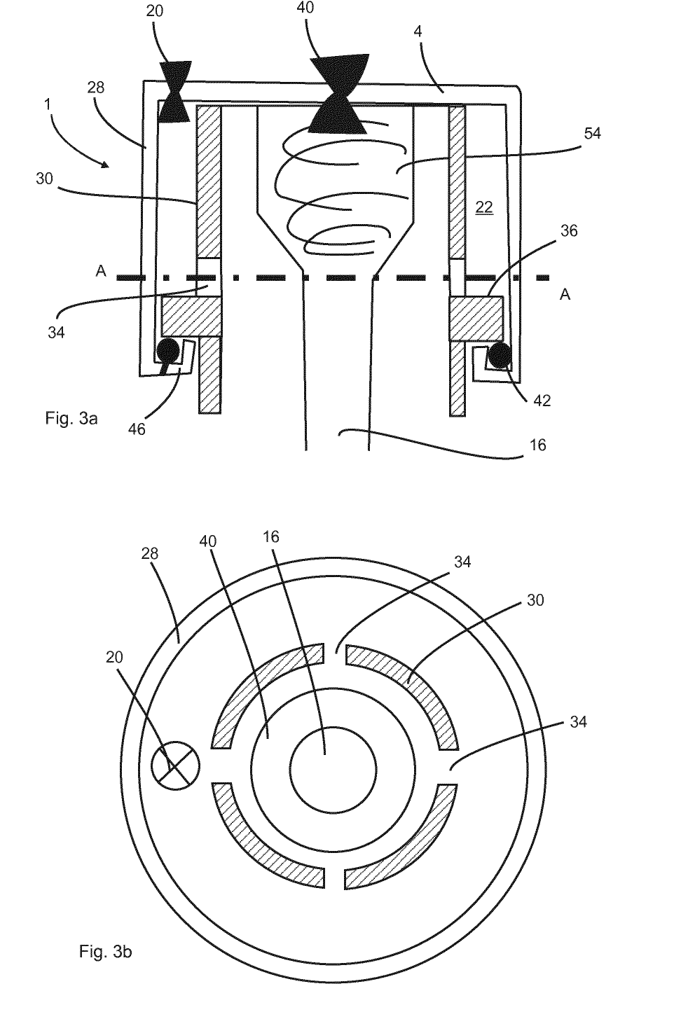

FIGS. 3a and 3b show two diagrams of a further embodiment of a container mouth with a cap arranged thereon;

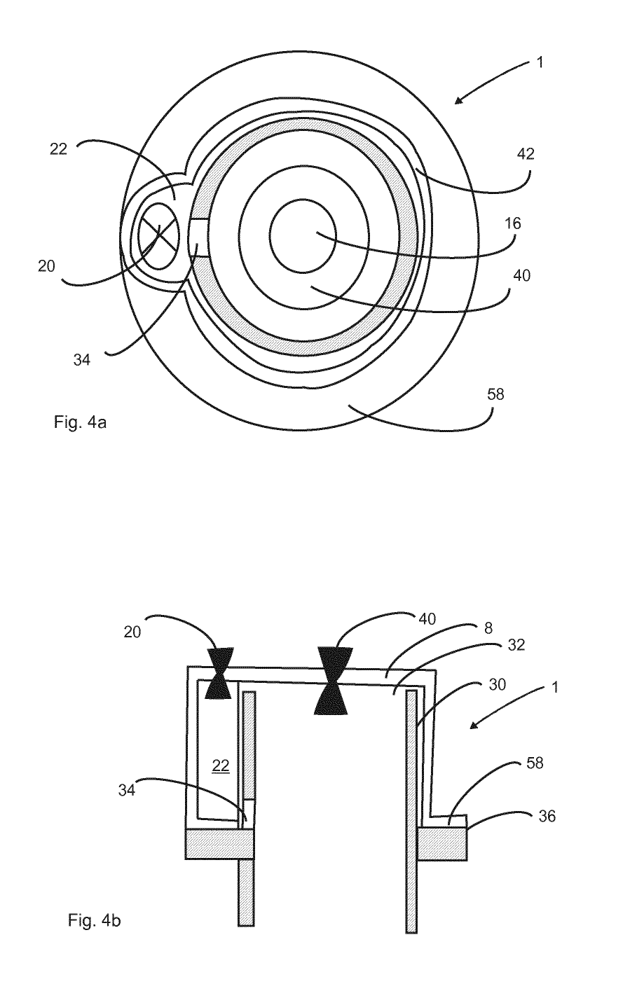

FIGS. 4a and 4b show a further embodiment according to the invention of a container with a container cap arranged thereon; and

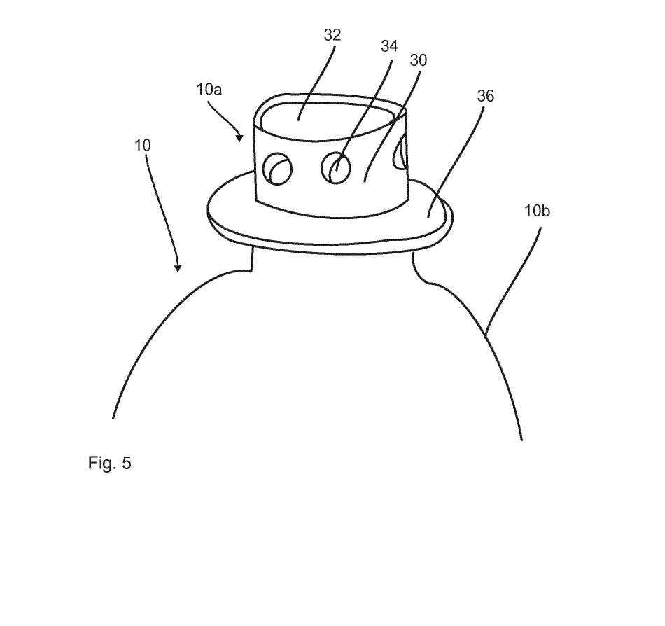

FIG. 5 shows a diagram of a mouth region of a container according to the invention.

FIG. 1 shows a diagram of a container 10, on which a container cap 1 is arranged. The container 10 has a main body which extends further below the figure here, and a mouth section 10a on which the cap 1 is arranged. The container 10 also has a ring-shaped section 36, such as in particular a carrying ring, which here serves also for arresting the container cap 1. For this purpose, the container cap 1 has an engaging section 46 which projects inwards radially in relation to the carrying ring 36 and a longitudinal axis L of the container and thus makes it possible to arrest the container cap 1. Furthermore, the plastic container 10 has in the mouth region 10a a mouth or opening 32, as is conventional in the prior art. In addition, however, the container 10 also has second openings 34, which are arranged here in a circumferential wall 30.

The container cap 1 here has a fastening means, denoted in its entirety by 6, for fastening the container cap 1 to the mouth section 10a. As mentioned above, this fastening means engages behind the carrying ring 36.

Reference 8 denotes a covering means which substantially completely closes the mouth 32 when the container cap is placed on the mouth 10a. Reference 44 denotes a first sealing means which may be configured here for example as an O-ring which can be pressed against the mouth rim 30a of the mouth 10a.

Reference 4 denotes a first opening which can be made in the covering means 8. Via this opening 4, liquid can be removed from the container. A valve 40 may be connected to this opening 4, via which valve the inward or outward flow of liquid into or from the container can be controlled. In particular, this valve 40 can be opened by a removal fitting such as, for example, a tap head.

Reference 12 denotes a predetermined opening section, in which a further opening can be made in the container cap 1. It can be seen that this predetermined opening section 12 is located outside of a region of the container defined by the mouth 32 or the rim thereof. This predetermined opening section 12 is adjoined by a cavity 22, which here surrounds the mouth region 10a of the container 10.

Reference E1 denotes a first plane, in which the opening 32 is arranged. Reference E2 denotes a second plane, in which the second opening is arranged. It can be seen that these two planes E1 and E2 are not parallel to one another and in particular are perpendicular to one another here.

Reference 20 denotes a second valve device which is assigned to the predetermined opening section 12 or to the opening formed thereby. In this way, it is possible to control a feed or removal of gas into or from the container.

Reference 16 denotes a line section which connects to the opening 4 and/or the valve 40. As mentioned above, this line section can project into the container and in particular can serve for the complete emptying thereof.

FIG. 2 shows a further embodiment of a container cap 1 according to the invention. In this embodiment, the two valve elements 20 and 40 are again provided. In contrast to the embodiment shown in FIG. 1, however, here a fastening of the cap 1 takes place via a thread 52 on a circumferential wall 30 of the mouth. For this purpose, the container has an external thread 10d which cooperates with sections 52a arranged on a container cap. Reference 10d correspondingly denotes a thread section which here serves for arresting the container cap. In addition, an engaging section 55 may also be provided, which can engage on a region of the container mouth. The first and second openings 32, 34 are also shown here again, wherein once again a gaseous medium can be conveyed into or out of the container via the opening 34.

Reference 42 in turn denotes a sealing device which seals the cavity 22 surrounding the container mouth. The carrying ring 36 thus also serves as a sealing region here. It can be seen that the (gas) passage openings 34 are arranged at an angle and in particular slope downwards towards the inside so that, as mentioned above, liquid medium entering the cavity 22 flows back into the container. Instead of the illustrated O-ring 42, however, an adhesive bonding or welding of the cap to the carrying ring 36 would also possible, in order to achieve sealing. Furthermore, reference 55 or the engaging device can also serve as quality assurance; that is to say as evidence of whether a container has already been opened. This can be implemented such that a predetermined breaking region is provided which breaks the first time the cap 1 is unscrewed from the container and thus provides evidence of opening. Advantageously, this quality assurance feature can also be arranged in such a way, for example on a circumferential wall of the container cap, that it can engage behind the carrying ring and thereby represents a quality seal that is visible from outside.

FIGS. 3a and 3b show a further embodiment of a device according to the invention. Here, too, the two valves 20 and 40 are again provided, wherein in this embodiment a widening body adjoins the valve 40, via which widening body the feeding of liquid into the container is facilitated. In this embodiment, the cap 1 is once again arrested by engaging behind the carrying ring 36 of the container. In addition, a riser 16 is also provided here again, as well as the circumferential cavity 22 via which the gas connection via the gas valve 20 is established. FIG. 3b shows a plan view along the line A-A shown in FIG. 3a. It is also possible to see here once again the liquid valve and the riser 16 connecting thereto. The openings 34 are also visible here. Reference 54 denotes a tapering section which adjoins the valve 40.

FIGS. 4a and 4b show a further embodiment of a container according to the invention with a container cap. In this embodiment, the cavity 22 is formed not around the entire container mouth but rather only in a section adjoining the opening 34. The opening 34 thus opens into said cavity 22 here, so that a gas exchange is possible via the valve 20.

As can be seen in particular also in FIG. 4b, here the container cap 1 has an annular disc 58 for arranging the container cap on the carrying ring 36, for example by adhesive bonding or welding.

Finally, FIG. 5 shows a diagram of a container 10 according to the invention. In addition to the conventionally provided opening 32, the openings 34 in the circumferential wall of the container are also provided here, as well as the carrying ring 36 which is arranged below these openings 34 and which, as mentioned above, can also serve here in particular for arresting and/or fastening and/or sealing the cap 1. Reference 10b denotes a main body of the container, which serves here in particular for accommodating liquids.

The applicant reserves the right to claim as essential to the invention all the features disclosed in the application documents in so far as they are novel individually or in combination with respect to the prior art.

### LIST OF REFERENCE SIGNS

1 container cap
2 receiving region
4 first opening
6 fastening means
8 covering means
10 container
10a mouth section
10b main body
10d external thread
12 predetermined opening section
16 line section
20 second valve device
22 cavity
30 circumferential wall
30a mouth rim
32 mouth
34 second openings
36 ring-shaped section, carrying ring
40 valve
42 sealing device
44 first sealing means
46 engaging section
52 thread
52a sections
54 tapering section
55 engaging section
58 annular disc
L longitudinal axis
E1 first plane
E2 second plane
A-A illustrated line

1. A container cap for liquid containers, comprising a receiving region for receiving a mouth section of the container, a fastening means for arresting the container cap on the container, and a covering means for completely covering a mouth of the container, wherein a first opening is present in this covering means when the container cap is arrested on the container, via which opening a first fluid can be removed from or fed to the liquid container, wherein this opening is located at least partially within the mouth cross-section of the mouth of the liquid container
wherein
the container cap has a predetermined opening section which is located outside of the mouth of the container and by means of which a flow connection to the internal volume of a liquid container on which the container cap is arrested can be established.

2. The container cap according to claim 1,
wherein
the predetermined opening section is spaced apart from the first opening.

3. The container cap according to claim 1,
wherein
the first covering means is configured as a covering surface which projects beyond the mouth of the liquid container.

4. The container cap according to claim 3,
wherein
the predetermined opening section is formed in the covering surface.

5. The container cap according to claim 1,
wherein
the container cap has a first sealing means for sealing the covering means with respect to the mouth rim of the mouth.

6. The container cap according to claim 1,
wherein
a cross-section of the container cap is larger than a mouth cross-section of the liquid container so that, when the container cap is screwed onto the liquid container, a gas channel which runs at least partially around the mouth of the container is formed.

7. The container cap according to claim 1,
wherein
the container cap has at least one valve device.

8. The container cap according to claim 7,
wherein
the valve device is assigned to the predetermined opening section.

9. A liquid container having a container cap with a valve device therein, said valve device in a predetermined opening section when the cap is arrested thereon,
wherein
the liquid container has, when closed by the container cap, an opening via which the liquid container is flow-connected to an intermediate space formed between the liquid container and the container cap.

10. A method for removing liquid from a liquid container, wherein a container cap is arrested on a mouth of said liquid container so as to allow removal of liquid from the container while the cap is arrested on the liquid container,
wherein
a first opening is made in the container cap in order to enable a first liquid connection for removing the liquid from the liquid container, and a second opening is made in the container cap in order to add a second fluid connection between the interior of the liquid container and the environment surrounding the liquid container, wherein one opening is formed within a mouth cross-section of the container cap and the second opening is formed outside of the mouth cross-section.
